(19) United States
(12) Patent Application Publication
(10) Pub. No.: US 2002/0127522 A1
(43) Pub. Date: Sep. 12, 2002

(54) Method for teaching fractions

(76) Inventor: Ryoko Fukushima, Setagaya-ku (JP)

Correspondence Address: MILORD & ASSOCIATES, 2029 CENTURY PARK EAST, SUITE 1700, LOS ANGELES, CA, 90067

(21) Appl. No.: 10/014,088

(22) Filed: Dec. 10, 2001

Related U.S. Application Data
(60) Provisional application No. 60/255,285, filed on Dec. 13, 2000.

(51) Int. Cl. G09B 27/08

(52) U.S. Cl. 434/131

(57) ABSTRACT

A method of teaching mathematical operations using a first device having a plurality of first columns and a plurality of first rows and a plurality of first cells created by the intersection of the first columns and the first rows. The columns having a top region wherein numbers are inserted within each cell in ascending order. The rows have a first end wherein numbers are inserted within each cell in ascending order. The result of the multiplication of each number within each of the top region of the columns and each number within each of first end of the rows is inserted within each cell of the intersection therebetween.

PRIORITY CLAIM

This application claims priority from provisional patent application No. 60/255,285 filed on Dec. 13, 2000.

### FIELD OF THE INVENTION

This invention relates to the field of education in general, and particularly to a method of teaching fractions and mathematical calculations involving the same.

### BACKGROUND OF THE INVENTION

Various teaching games have been utilized in the prior art for educational and amusement purposes. In addition, board games involving mathematical calculations are also known.

U.S. Pat. No. 5,679,002 to Scelzo discloses an apparatus and a method for playing a board game which enables a player to gain an understanding of the concept of fractions and arithmetical operations while manipulating game-pieces. A game board having arithmetic operators randomly indicated thereon is traversed by a game piece, and a corresponding card having a similar arithmetic operator is selected such that a question may be posed. A fraction board and a slide box are used in an attempt to visually determine an answer to a selected question.

U.S. Pat. No. 5,470,234 to Sher discloses a circular, piece-matching math educational aid. It includes a circular holding plate and various pie shaped fraction pieces. A combination of any number of the fraction pieces will result in a fraction that may be determined by the fraction scale on the circular holding plate. The holding plate is also modified in a spiral shape to allow the determination of fractions that would exceed 360°.

The prior art does not address the need for an education aid that would allow students to become familiar with fractions and arithmetical operations therewith. Therefore, there remains a long standing and continuing need for an advance in the art of educational aids that is simpler in both design and use, is more effective in teaching students, and is cost efficient in its construction and use.

### SUMMARY OF THE INVENTION

The present invention entails a first device for use in teaching mathematical operations and extremely useful in teaching fractions. The first device consists of a multiplications table having a plurality of columns and rows as desired by the user. By tracing appropriate numbers within the columns and rows, mathematical operations can easily be performed and taught to a student. A second device also has a plurality of rows and columns and is used for determining factors of numbers that ascend along a top row thereof. In keeping with the principles of the present invention, a unique math teaching aid device is herein disclosed.

Accordingly, it is a general object of the present invention to overcome the disadvantages of the prior art.

In particular, it is an object of the present invention to provide a method of introducing individuals to mathematical operations with visual reinforcement.

It is another object of the present invention to provide a method of teaching mathematical operations in a way that is simple to understand.

It is another object of the present invention to provide a method of teaching difficult math fractions in a manner that the student will enjoy.

It is yet another object of the present invention to provide a math teaching device that uses a visual aid to reinforce the mathematical operations and numbers.

It is yet another object of the present invention to provide a math teaching device that uses a visual aid to increase a students comprehension of the mathematical operations and numbers.

It is a further object of the present invention to provide a teaching device that is easy to manufacture and use.

It is another object of the present invention to provide a math teaching device that is fully effective for its intended purpose.

It is another object of the invention to provide a math teaching aid which is inexpensive to produce.

Such stated objects and advantages of the invention are only examples and should not be construed as limiting the present invention. These and other objects, features, aspects, and advantages of the invention herein will become more apparent from the following detailed description of the embodiments of the invention when taken in conjunction with the accompanying drawings and the claims that follow.

### BRIEF DESCRIPTION OF THE DRAWINGS

It is to be understood that the drawings are to be used for the purposes of illustration only and not as a definition of the limits of the invention.

In the drawings, wherein similar reference characters denote similar elements throughout the several views:

FIG. 1 is an illustration of device 10.

FIG. 2A is an illustration of a second device 20.

FIG. 2B is a continued illustration of second device 20.

### DETAILED DESCRIPTION OF THE INVENTION

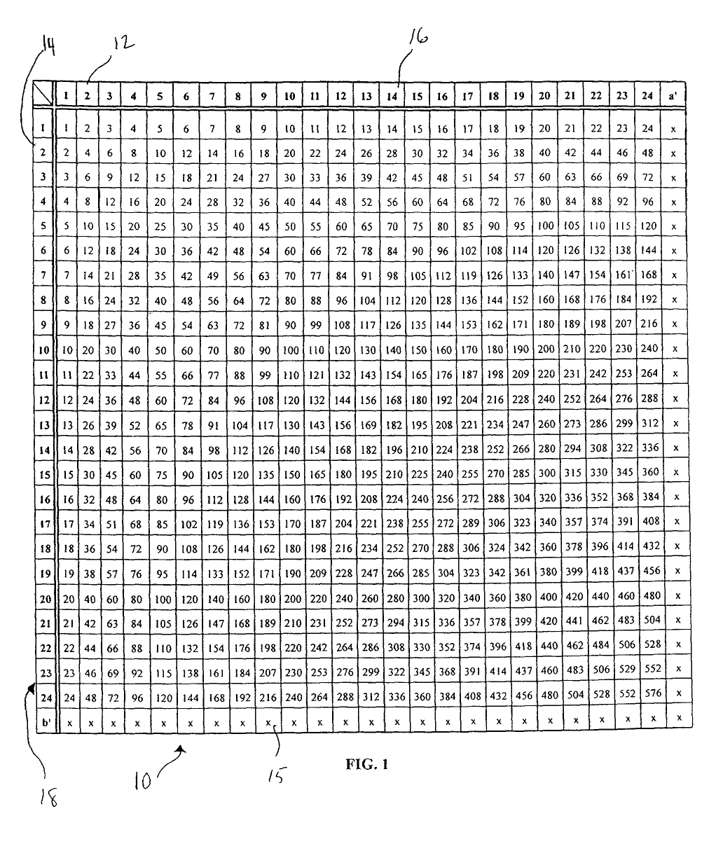

Referring to FIG. 1, therein is illustrated one preferred embodiment of a device 10 used in teaching mathematical operations. Device 10 has a plurality of columns 12 and a plurality of rows 14 such that a multiplication table is formed having a plurality of cells 15. At a top region 16 of columns 12 numerals are contained within each of the cells 15 in ascending order. At a first end 18 of rows 14 numerals are contained within each of the cells 15 in ascending order in a direction distal to said top region 16. Columns 12 may be extended to any desired numeral as indicated by a′. In addition, rows 14 may be extended to any desired numeral as indicated by b′. The resulting numeral from the multiplication of a′ and b′ is indicated within the intersecting corresponding cell 15. “x” represents the resulting multiple of a′ and b′ with corresponding numerals.

The following examples illustrate the use of the present invention and, of course, should not be construed as in any way limiting its scope, but rather providing at least preferred embodiments for practicing the same. It is to be understood that although specific examples are provided with specific numbers, that the principles underlying the specific calculations are applicable to calculations involving alternate numbers.

### Example 1.

### Division

Device 10 may be used in teaching division of whole numbers. For example, if the problem calls for the division of 21 by 7 or 21/7=?, the user is taught to find the number 7 on either top region 16 of column 12 or on first end 18 of row 14. For purposes of illustration, we will use the 7 that appears on top region 16, after which the user checks in the cells 15 below the number 7 until the number 21 is found. After the number 21 is found, the user moves towards first end 18 within the same row as the number 21 and obtains the numeral 3 within that cell 15. Accordingly, the answer to the problem is 3.

### Example 2.

### Determining the Least Common Multiple

Device 10 may be used in teaching the determination of the least common multiple (“LCM”) for two or more nonzero whole numbers. The LCM is the smallest whole number that is divisible by each of the numbers. Two common methods exist in the prior art for finding the LCM.

The first method of determining the LCM involves calculating the multiples of each number. For example, the LCM of 8 and 14 are as follows:

Multiples of 8 are: 8, 16, 32, 40, 48, 56, 64, . . .

Multiples of 14 are: 14, 28, 42, 56, 70, . . .

Accordingly, it can be determined that the LCM of 8 and 14 is 56. How ever, this method involves determining the multiples of each number and is time consuming.

The second method of determining the LCM according to the prior art involves factoring each of the numbers into primes. Then for each of the different prime numbers derived as a result, the following steps should be utilized: 1) Count the number of times the number appears in each of the factorizations; 2) take the largest of those two counts; 3) write down that prime number equivalent to the number of times as the count in step 2. For example the primes for 8 and 14 are:

8=2×2×2

14=2×7

Accordingly, the number 2 appears three times for the first factorization and once in the second factorization. Thus we take the larger number of three appearances. The number 7 appears once in the second factorization and zero times in the first factorization. Accordingly we take the number 7 once. Therefore, the LCM is the product of three 2's and one 7 as follows:

2×2×2×7=56

It follows that numerous calculations must be conducted using the second prior art method to determine the LCM.

The instant device 10 eliminates the lengthy method of determining the multiples of each number or factoring each number. Using device 10, the user is taught to find the number 8 on either top region 16 of column 12 or on first end 18 of row 14. For purposes of illustration, we will use the number 8 and the number 14 that appear on top region 16, after which the user checks in the cells 15 within the columns directly below the numbers 8 and 14. As the user moves below the numbers 8 and 14, the first number that appears in both columns 12 will be the LCM which is the number 56.

### Example 3.

### Renaming Fractions

Fractions have a numerator on top and a denominator on the bottom. Sometimes a mathematical problem calls for an equivalent fraction of a given fraction where the resultant value is the same. For example:

$$\frac{3}{4} = \frac{9}{?}$$

Using the prior art method, one would have to determine the number by which 3 was multiplied in order to obtain the second numerator and then multiply the original denominator, 4, by the same number. Using device 10, the user finds the original numerator and denominator on the first end 18 of rows 14. Then the user moves distal to the first end 18 within the same row as the numerator 3 until the second numerator 9 is located. Then the user follows that same column 12 down until the point of the intersection with the row 14 of the original denominator 4 and the number in that cell 15 is the answer, which in this case the answer is 12. The same principle would apply when the original fraction is an improper fraction.

### Example 4.

### Improper Fraction/Mixed Fraction

Improper fractions have a numerator which is greater than or equal to the denominator. Mixed fractions are a combination a whole number and a fraction.

Change 8/3 into a mixed number: First the user locates the denominator on the top region 16 of column 12. Then the user proceeds downward in the same column until a cell 15 is located having a number that is the closest to the numerator without exceeding the same, in this case 6. Then the user traces within the same row towards the first end 18, and the resultant number is the whole number of the mixed number, in this case 2. The 6 which was found earlier is subtracted from the original numerator, thus resulting in a mixed number of.

$$2 \frac{2}{3} .$$

Change

$$4 \frac{2}{3}$$

into an improper fraction: The user locates the whole number 4 on the first end of row 14 and the denominator 3 on the top region 16 of column 12. The intersection of the numerator's row and the whole number's column is the cell 15 which contains the number which must be added to the original numerator, in this case 12. Accordingly, the answer is

$$\frac{14}{3} .$$

### Example 5.

### Greatest Common Factor

Device 10 may be used in teaching the determination of the greatest common factor (“GCF”) for two or more nonzero, whole numbers. The GCF of two or more numbers is the largest whole number that divides each of the numbers. Two common methods exist in the prior art for finding the GCF.

The first prior art method of determining the GCF involves calculating the factors for each number and listing the resulting factors, then choosing the largest common factor. For example, the GCF of 36 and 54 are as follows:

Factors of 36 are: 1, 2, 3, 4, 6, 9, 12, 18, 36

Factors of 54 are: 1, 2, 3, 6, 9, 18, 27, 54

The common factors are: 1, 2, 3, 6, 9, and 18. Accordingly the GCF is 18. However, this method involves determining the multiples of each number and is time consuming.

The second method of determining the GCF according to the prior art involves determining the prime factors for each number and then multiplying the common prime factors. For example the primes for 36 and 54 are:

36=2×2×3×3

14=2×3×3×3

Accordingly, the common prime factors are 2, 3, and 3. Therefore, the GCF is the product of the multiplication of the common prime factors:

2×3×3=18

It follows that numerous calculations must be conducted using the second prior art method to determine the GCF.

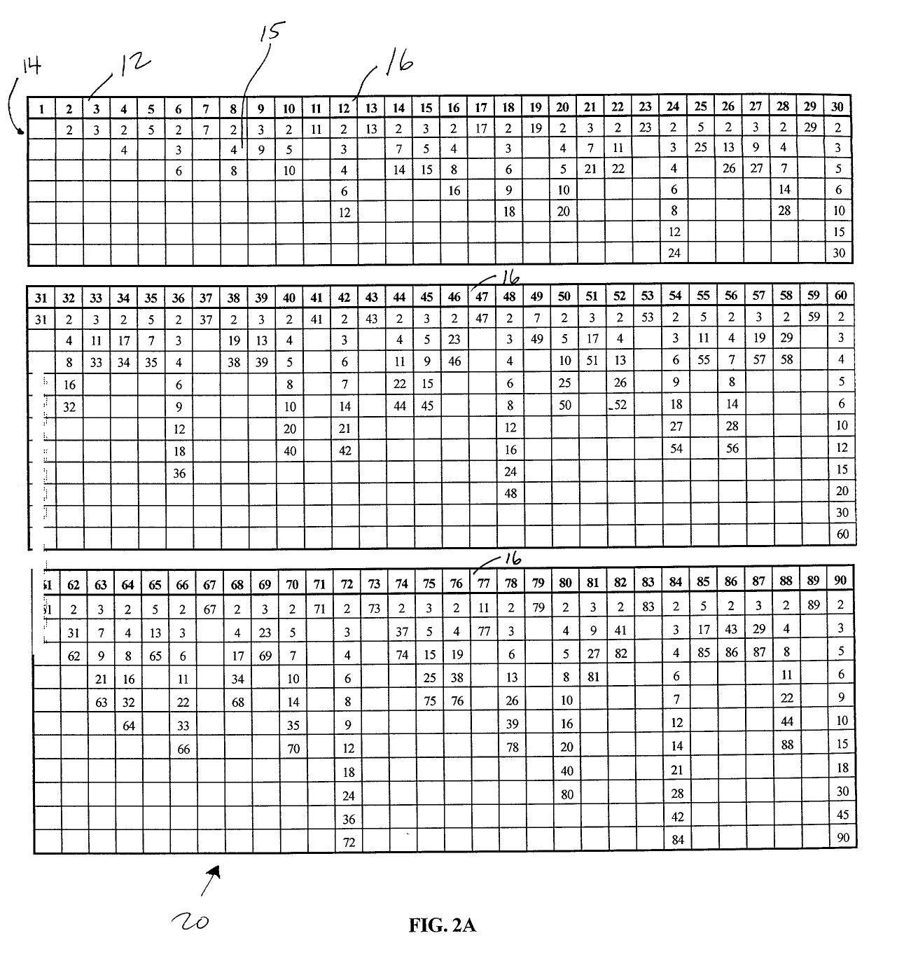

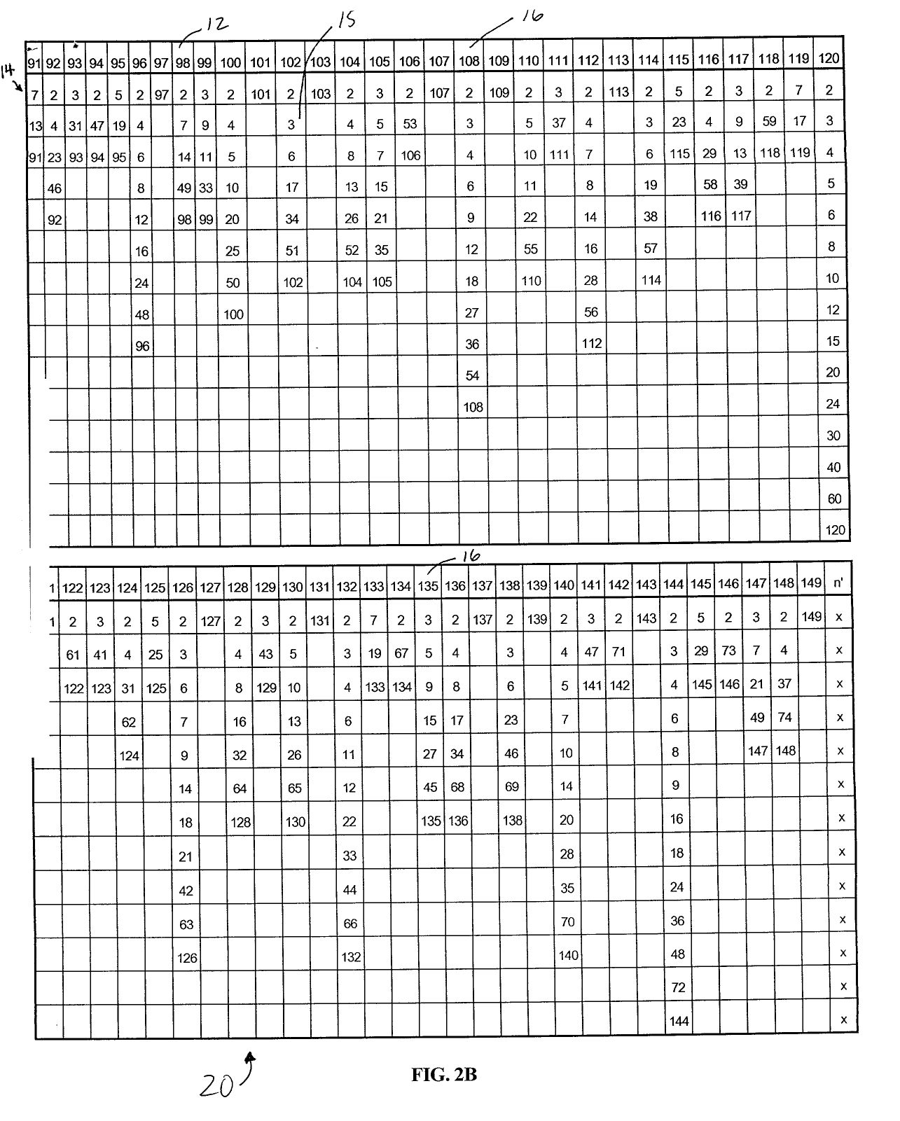

Now also referring to FIGS. 2A and 2B, a second device 20 is therein illustrated for teaching mathematical operations. Device 20 has a plurality of columns 12 that extend horizontally and a plurality of rows 14 that extend vertically such that a table is formed having a plurality of cells 15. At a top region 16 of columns 12 numerals are contained within each of the cells 15 in ascending order in each column 12. For each numeral that is contained within each column of top region 16, the factors of each number are listed thereunder within each corresponding column and each having an individual cell 15 therefore in ascending order. Columns 12 may be extended to any desired numeral as indicated by n′ and the corresponding factors listed thereunder as indicated by x in FIG. 2B.

The instant second device 20 eliminates the lengthy method of determining the factors for each number or determining the common prime factors and multiplying the same to determine the GCF therefor. Using second device 20, the user is taught to find the numbers for which the GCF is sought on the top region 16 of column 12. For purposes of illustration, we will use the number 12 and the number 24 that appear on top region 16, after which the user checks in the cells 15 within the corresponding columns directly below the numbers 12 and 24. As the user moves below the numbers 12 and 24 in a direct line, the greatest common number that appears in both of the respective columns below 12 and 24 will be the GCF. In this case the GCF is 12.

### Example 6.

### Reduction of Fractions

In reducing a fraction, one must divide the numerator and the denominator by the greatest common factor of both the numerator and the denominator or keep dividing the numerator and denominator by any common factor until there are no more common factors between them. Using device 10, the user is able to easily reduce a fraction into its most simplest terms.

For example, in reducing

$$\frac{36}{48}$$

into its simplest terms, a user locates the numerator and the denominator on the same column 12 or the same row 14 of device 10. For illustration, but not limitation, we will use column 12. It can be discerned that the numbers 36 and 48 appear below both the columns designated by 6 and 12 of top region 16. When the numerator and denominator appears in two or more columns, then the column having the greater value must be chosen. In this case the column designated by 12 in the top region 16 is chosen. The user then traces the row corresponding to the numerator 36 to the first end 18 of row 14, and the resulting numerator is 3. The user then traces the row corresponding to the denominator 48 to the first end 18 of row 14, and the resulting denominator is thus 4. Accordingly,

$$\frac{36}{48}$$

can be reduced to

$$\frac{3}{4} .$$

If the numerator and denominator do not both appear in the same column 12 or row 14, then second device 20 may be used to reduce the fraction. For example, in reducing

$$\frac{50}{84}$$

into its simplest terms, a user locates the numerator and the denominator on the top region 16 of column 12. Then the user looks down below each of the numbers 50 and 84 for the largest common number, in this case being 2, and dividing the numerator and denominator by the largest common number. Accordingly, the result in the instant example is,

$$\frac{25}{42} .$$

In addition, the largest common number is also the greatest common denominator.

Example 7.

### Addition of Fractions

Device 10 may be used to teach addition of fractions. For example in adding

$$\frac{3}{8} + \frac{1}{6} ,$$

one needs to determine the LCM of 8 and 6. As described in more detail above in relation to determining the LCM, the numbers 8 and 6 are located on top region 16. Then the column is traced below 6 and 8 until a common number is located, in this case 24. Then trace each cell 15 containing 24 within the same row 14 towards first end 18, in this case for 8 the result is 3 and for 6 the result is 4. Multiply the resulting number from first end 18 by the numerator and denominator of each of the fractions respectively, and as such the least common denominator will be determined. In the instant example,

$$\frac{3 \times 3}{8 \times 3} + \frac{1 \times 4}{6 \times 4} = \frac{9}{24} + \frac{4}{24} = \frac{13}{24} .$$

The same principle may be applied to the addition of multiple fractions and the principles taught above may be used to also reduce the resulting answer to its most lowest terms.

### Example 8.

### Subtraction of Fractions

Device 10 may be used to teach subtraction of fractions. For example in adding

$$\frac{3}{4} - \frac{2}{8} - \frac{3}{12} ,$$

one needs to determine the LCM of 4, 8 and 12. As described in more detail above in relation to determining the LCM, the numbers 4, 8 and 12 are located on top region 16. Then the column is traced below 4, 8, 12 until a common number is located, in this case 24. Then trace each cell 15 containing 24 within the same row 14 towards first end 18, in this case for 4 the result is 6, for 8 the result is 3, and for 12 the result is 2. Multiply the resulting number from first end 18 by the numerator and denominator of each of the fractions respectively, and as such the least common denominator will be determined. In the instant example,

$$\frac{3 \times 6}{4 \times 6} - \frac{2 \times 3}{8 \times 3} - \frac{3 \times 2}{12 \times 2} = \frac{18}{24} - \frac{6}{24} - \frac{6}{24} = \frac{6}{24} .$$

Now we reduce

$$\frac{6}{24}$$

into its most lowest terms using the method taught in detail above and obtain.

$$\frac{1}{4} .$$

### Example 9.

### Multiplication of Fractions

Device 10 may be used in teaching multiplication of fractions. For example in multiplying,

$$3 \frac{3}{4} \times \frac{3}{5} ,$$

one needs to convert the mixed fraction to an improper fraction first as taught above resulting in.

$$\frac{15}{4} \times \frac{3}{5} = \frac{45}{20} .$$

As described in more detail above, the fraction is then reduced by dividing by 5 and results in

$$\frac{9}{4} ,$$

which is then changed to a mixed fraction, with the method taught in detail above, and results in

$$2 \frac{1}{4} .$$

### Example 10

### Division of Fractions

Device 10 may be used in teaching division of fractions. For example in determining the answer to

$$2 \frac{1}{4} \div \frac{1}{6} ,$$

one needs to convert the mixed fraction to an improper fraction first as taught above resulting in.

$$\frac{9}{4} \div \frac{1}{6} .$$

The reciprocal of the divisor is then taken and multiplied by the dividend, in the present example

$$\frac{9}{4} \times \frac{6}{1} .$$

Before multiplying the two fractions, one may choose to reduce the fractions using device 10 as describe above in relation to renaming fractions and determine that

$$\frac{9}{24} \times \frac{63}{1}$$

results. Multiplying the numerators and the denominators results in

$$\frac{27}{2} ,$$

which is the n reduced as described in detail above to

$$13 \frac{1}{2} .$$

While the above description contains many specificities, these should not be construed as limitations o n th e scope of the invention, but rather as an exemplification of preferred embodiments thereof. Many other variations are possible without departing from the essential spirit of this invention. Accordingly, the scope of the invention should be determined not by the embodiments illustrated, but by the appended claims and their legal equivalents.

What is claimed is:

1. A method for teaching mathematical operations, comprising
providing a first device having a plurality of first columns and a plurality of first rows;
providing a top region along said plurality of first columns;
providing a first end along said plurality of first rows;
providing a plurality of cells at a plurality intersection points between said first columns and said first rows;
providing numerals within said plurality of cells; and
teaching a user to perform a mathematical operation through using said device and the numerals contained therein.

2. The method of claim 1, wherein the step of teaching a mathematical operation involves teaching a method of division and further comprises the steps of:
locating a divisor on said top region;
locating a dividend directly below said divisor within one of said plurality of first columns;
tracing along one of said first rows within which said dividend appears towards said first end;
determining an answer to the divisional operation as appearing within said first row at said first end.

3. The method of claim 1, wherein the step of teaching a mathematical operation involves teaching a method of determining a least common multiple for at least two numbers and further comprises the steps of:
locating at least a first number and at least a second number on said top region;
locating a first numeral of equal value below said first column within which said first number appears and said first column within which said second number appears; and
determining the least common multiple for said first number and said second number to be the first numeral of equal value that first appears within each respective first columns.

4. The method of claim 1, wherein the step of teaching a mathematical operation involves teaching renaming of fractions into fractions having an equivalent value and further comprises the steps of:
locating a first numerator and locating a second denominator on said first end of said plurality of first rows;
tracing along said respective first rows distal to said first end and determining fractions of equal value by selecting a second numerator from the same first row as said first numerator and selecting a second denominator from the same first row as said second denominator and directly below said first column of said second numerator.

5. The method of claim 1, wherein the step of teaching a mathematical operation involves teaching conversion of an improper fraction into a mixed number and further comprises the steps of:
locating a denominator on said top region;
searching below said denominator within said first column for a first number that does not exceed a numerator of the improper fraction;
tracing along said first row within which said first number appears towards said first end of said first row and locating a second number, said second number being a whole number of a resulting mixed number; and
subtracting said first number from said numerator to determine a resulting numerator of the mixed number.

6. The method of claim 1, wherein the step of teaching a mathematical operation involves teaching conversion of a mixed number into an improper fraction and further comprises the steps of:
locating a whole number of said improper fraction on said top region;
locating a denominator of said improper fraction on said first end;
finding a first number at a point of intersection between the column containing said whole number and the row containing the denominator;
adding said first number to a first numerator of said mixed number to determine the resulting improper fraction.

7. The method of claim 1, wherein the step of teaching a mathematical operation further comprises the steps of:
providing a second device having a plurality of second columns;
providing a second top region having a first numeral therein, and said first numeral being in ascending order within each top region of each of said subsequent second columns;
providing a plurality of cells below each of said second top regions; and
providing a plurality of factors for each of said first numeral below each of said first numerals within said cells of each respective column.

8. The method of claim 7, wherein the step of teaching a mathematical operation involves teaching a method of determining the greatest common factor of at least two numbers and further comprises the steps of:
locating said at least two numbers on said second top region;
looking below said at least two numbers within each respective column for a largest common number which is the resulting greatest common factor for said at least two numbers.

9. The method of claim 1, wherein the step of teaching a mathematical operation involves teaching a method of reducing fractions and further comprises the steps of:
locating a first numerator and a first denominator of a fraction within the same column of said first device;
choosing the column having a greater number in the first region if the first numerator and denominator appear in more than one column simultaneously;
tracing along one of said rows within which said first numerator appears towards said first end where by a second numerator is selected; and
tracing along one of said rows within which said second numerator appears towards said first end whereby a second denominator is selected.

10. The method of claim 7, wherein the step of teaching a mathematical operation involves teaching a method for reducing fractions and further comprises the steps of:
locating a first numerator and a first denominator on said second top region of said second device;
locating the largest common number below each column of said first numerator and said first denominator;
tracing along one of said rows within which said dividend appears towards said first end;
dividing said first numerator and said first denominator by the largest common number and thereby obtaining a reduced fraction.

11. The method of claim 3, wherein the step of teaching a mathematical operation involves teaching a method of adding at least a first fraction having a first numerator and a first denominator and a second fraction having a second numerator and a second denominator and further comprises the steps of:
determining the least common multiple of said first denominator and said second denominator;
tracing along each of said rows within which said least common multiple appears towards said first end and obtaining a first number for the first denominator and a second number for the second denominator;
multiplying said first numerator and said first denominator by said first number and multiplying said second numerator and said second denominator by said second number; and
adding the first resultant numerator to the second resultant numerator and placing the resultant over one of the first resultant denominator and the second resultant denominator.

12. The method of claim 3, wherein the step of teaching a mathematical operation involves teaching a method of subtracting at least a first fraction having a first numerator and a first denominator from a second fraction having a second numerator and a second denominator and further comprises the steps of:
determining the least common multiple of said first denominator and said second denominator;
tracing along each of said rows within which said least common multiple appears towards said first end and obtaining a first number for the first denominator and a second number for the second denominator;
multiplying said first numerator and said first denominator by said first number and multiplying said second numerator and said second denominator by said second number; and
subtracting the first resultant numerator from the second resultant numerator and placing the resultant over one of the first resultant denominator and the second resultant denominator.
